(19) United States
(12) Patent Application Publication
(10) Pub. No.: US 2006/0198603 A1
(43) Pub. Date: Sep. 7, 2006

(54) System and method for extracting data from recording media

(76) Inventors: Cheng-Hao Yao, Taipei City (TW); Min-Lun Hsieh, Danshuei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/111,897

(22) Filed: Apr. 22, 2005

(30) Foreign Application Priority Data
Mar. 3, 2005 (TW) 094106476

(51) Int. Cl. H04N 5/91

(52) U.S. Cl. 386/68

(57) ABSTRACT

A system and method for extracting data from recording media scan a recording media so that a plurality of key frames and a plurality of time intervals can be extracted, wherein each of the plurality of key frames and each of the plurality of time intervals correspond to one of the scenes in the recording media. Afterwards, at least one selected key frame can be acquired. Eventually, a multimedia file can be outputted according to the selected frame. By acquisition of the plurality of key frames, the present invention allows of processing only key frames such that the amount of information needed processing can be reduced. Not all frames of the desired scenes are extracted from the recording media until a user output a multimedia file, so that the processing time for extracting data from the recording media can be concentrated in outputting multimedia files.

### FIELD OF THE INVENTION

The present invention relates generally to a system and a method for extracting of data from recording media, more particularly to a system and a method for extracting of data from recording media in accordance with key frames of a scene.

### BACKGROUND OF THE INVENTION

Owing to prosperous development of related technologies in digital photography devices as well as to the characteristics of shrinkage in sizes of electronic components and lower prices, the general public gradually accepts digital photography devices. It is expected that by means of digital photography devices, photography and audio can be combined to make content be presented with reality and continuity.

The recording media of digital photography devices includes a magnetic tape and a memory card. The common ways of storage are recording a plurality of scenes on a magnetic tape sequentially, or storing images in memory cards, wherein the scene means the moving picture representation during a continuous time period; that is, the movie generated between the time when a user presses the recording button of a photography device, and the time when the user presses the stop button thereof. Thereby each scene includes a plurality of frames. If the photography device adopts magnetic tape as the media for storing movies, therefore when a user wishes to extract the plurality of scenes on the recording media, he/she has to read the plurality of scenes sequentially.

Referring to FIG. 1, it shows the schematic diagram of prior-art extraction of a plurality of scenes. As shown in the figure, the system includes an extraction unit 20′, an editing unit 30′, an output unit 40′, and a storage unit 50′, wherein when a user uses the extraction unit 20′ to extract a plurality of scenes from a recording media 10′, he/she has to wait for 60 to 90 minutes in order to extract the plurality of scenes if the plurality of scenes takes 60 minutes. Then the user selects at least one of special-effect templates provided by the editing unit 30′, and applies the selected special-effect template to the plurality of scenes extracted by the extraction unit 20′ via the output unit 40′. In accordance with the complexity of special effects, the user has to further wait for a considerable period of time to make the output unit 40′ output the plurality of scenes that have been applied with the special-effect template. At last, when using the storage unit 50′ to store the plurality of scenes output by the output unit 40′ to a disc, the user has to wait for another 60 to 90 minutes in order to transform the file formats of the plurality of scenes, thereby he/she can store the plurality of transformed scenes to the disc.

As described above, in the process of extracting data from recording media, the user needs to wait for a period of time to execute the next step. In addition, the command from the user is required before the execution of each step. It's troublesome and inconvenient for the user to keep watch for the computer without completing all operation steps in a short time.

Consequently, a system and a method for extracting data from recording media proposed to solve the above problems not only can reduce waiting time for processes, but also is more convenient to use. Such a system and a method have been users' eager expectations for a long time, and have been kept in mind by the present inventors. Owing to the consciousness of improvements, the present inventors delve into their personal expertise. After multi-faceted researches, designs, and monographic studies, a system and a method for extracting data from recording media have finally been proposed to solve the foregoing problems.

### SUMMARY

The main purpose of the present invention is to provide a system and a method for extracting data from recording media. By means of scanning the recording media, the system and the method extract a plurality of key frames, and each of the plurality of key frames corresponds to a scene of the recording media such that each step processes the plurality of key frames only. Not all frames of the corresponding scene are extracted from the recording media until the user outputs multimedia files. In this way, the process time required for extracting data from recording media can be concentrated in the step of outputting multimedia files, thus the waiting time for executing each operation step is reduced.

The secondary purpose of the present invention is to provide a system and a method for extracting data from recording media that disclose an editing unit and provide at lease one special-effect template for users to select from. In addition, the editing unit further provides the corresponding special-effect template according to environment configurations of photography devices; thereby the viewing quality of multimedia can be improved.

In order to achieve foregoing advantages, the system and the method for extracting data from recording media of the present invention use a scan unit to scan a recording media so that a plurality of key frames and a plurality of time intervals can be extracted, wherein each of the plurality of key frames and each of the plurality of time intervals correspond to one of the scenes in the recording media. Afterwards, the plurality of key frames is selected via a selection unit so that at least one selected frame can be acquired for an output unit to generate a multimedia file. Moreover, the present invention further includes an editing unit to provide a plurality of special-effect templates for users to select from. In addition, the editing unit also provides the corresponding special-effect template according to environment configurations of photography devices extracted from a preset extraction unit.

### BRIEF DESCRIPTION OF THE DRAWINGS

FIG. 1 is a block diagram of extraction of a plurality of scenes in prior art;

FIG. 2A is a schematic diagram of a preferred embodiment of the present invention;

FIG. 2B is a schematic diagram of data stored in a recording media;

FIG. 2C is a schematic diagram of distinct scenes in a recording media;

FIG. 3 is a schematic diagram of another preferred embodiment of the present invention;

FIG. 4 is a flow chart of a preferred embodiment of the present invention;

FIG. 5A is a schematic diagram of a multimedia editing panel for selecting a recording media;

FIG. 5B is a schematic diagram of a multimedia editing panel for displaying key frames;

FIG. 5C is a schematic diagram of a multimedia editing panel for displaying selected frames;

FIG. 5D is a schematic diagram of a multimedia editing panel for storing multimedia files;

FIG. 6 is a flow chart of another preferred embodiment of the present invention;

FIG. 7 is a schematic diagram of another preferred embodiment of the present invention;

FIG. 8 is a flow chart of another preferred embodiment of the present invention;

FIG. 9 is a schematic diagram of special-effect templates corresponding to environment configurations provided by the present invention;

FIG. 10 is a flow chart of special-effect templates corresponding to environment configurations provided by the present invention; and

FIG. 11 is another flow chart of special-effect templates corresponding to environment configurations provided by the present invention;

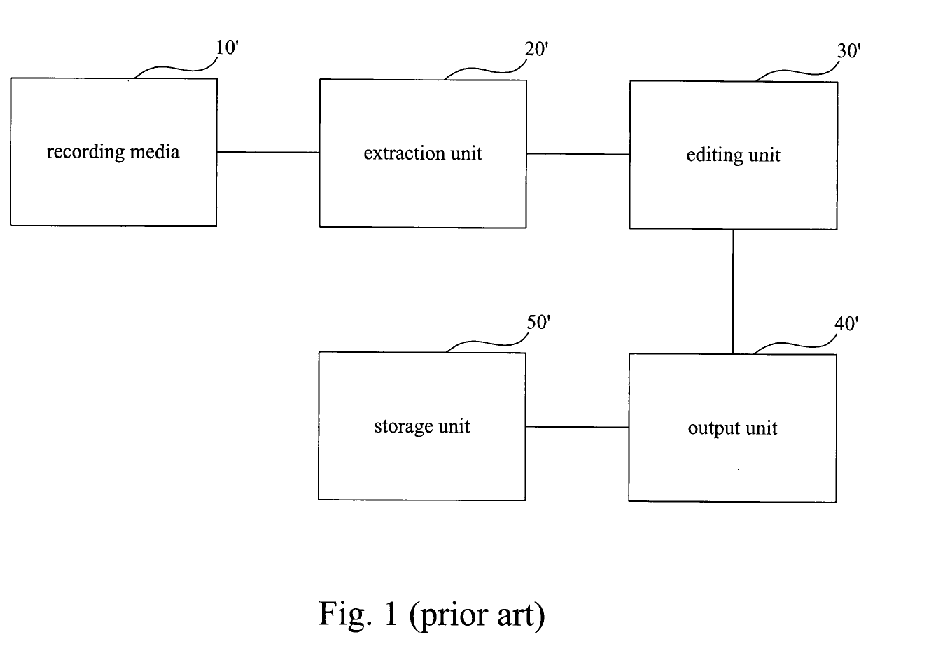

### DETAILED DESCRIPTION

In order to make the technological characteristics of the present invention be further understood and recognized, the preferred embodiment of the present invention and the accompanying detailed descriptions are described as follows.

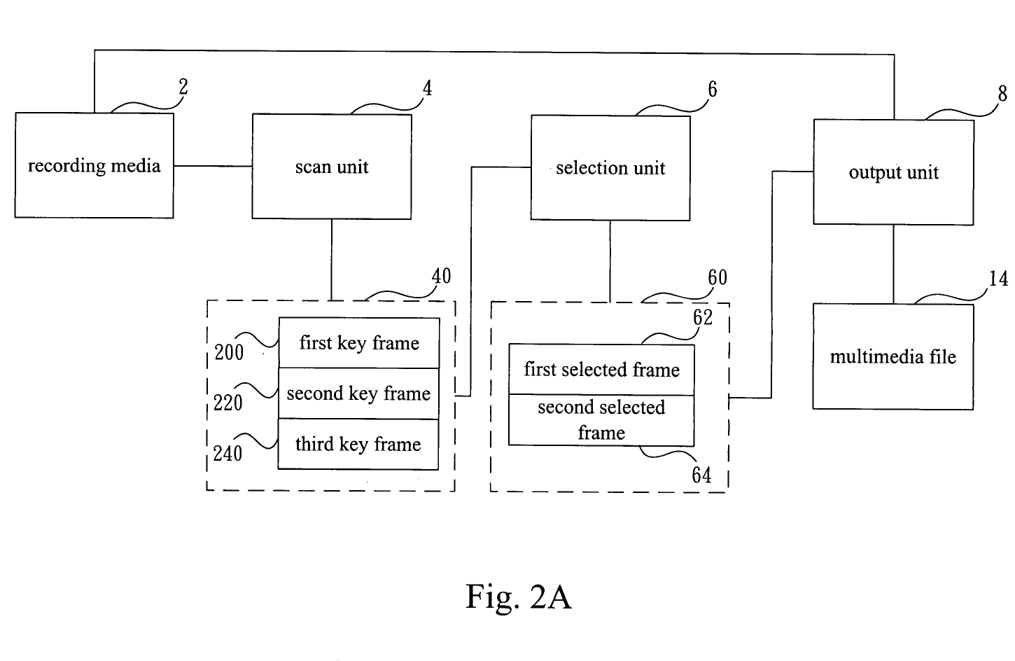

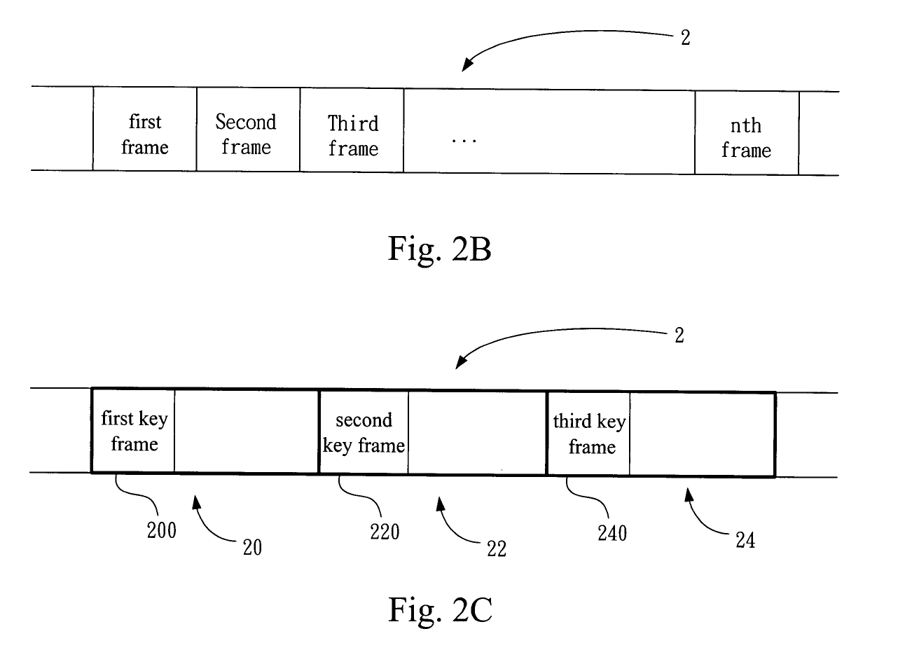

In prior art, because a plurality of frames in all scenes stored in a recording media have to be read, when a user extracts data from the recording media, he/she cannot proceed to the next step until the execution of all scenes is completed, which makes the user have to wait for a considerable time between execution steps. Accordingly, the present invention proposes a system and a method for extracting data from recording media to solve the said problem. In the following embodiment, a magnetic tape is used as an example of the recording media in the present invention. However, the recording media of the present invention is not limited to magnetic tapes only. The recording media can be a memory card, a videotape, a digital disc, or related recording media that is able to record data. Referring to FIG. 2A, a schematic diagram of a preferred embodiment of the present invention is shown. As shown in the figure, the present invention includes a recording media 2, a scan unit 4, a selection unit 6, and an output unit 8. In FIG. 2B, the recording media 2, which is a magnetic tape, includes a plurality of frames. In the present invention, the time difference between the recording times of two adjacent frames is compared in order to detect if any scene in the plurality of frames in the recording media 2 is changed or not. When the time difference is greater than a standard time interval, a recording break (for example, a change in scene) is judged to happen between two adjacent frames. Also referring to FIG. 2C, by which the present invention can distinguish that there are three scenes in the recording media 2, which include a first scene 20, a second scene 22, and a third scene 24. In addition, each scene includes a plurality of frames.

As described above, the present invention uses information of recording time as the basis for detecting change of scenes. In addition, the present invention can also use related methods for detecting change of scenes. For example, when the recording media adopts an MPEG compression format to record frame data, because there is cross-reference between frames in movies with MPEG protocol, the higher the reference rate is, the more alike the two frames are. In such a movie, if change of scenes happens, the reference rate between adjacent frames is lower. Therefore, by counting mutual reference rates between MPEG frames, the occurrences of change of scenes can be rapidly detected in video compression data.

The scan unit 4 scans the recording media 2 to acquire a virtual segment. The virtual segment includes a plurality of key frames 40, wherein the plurality of key frames 40 includes a first key frame 200, a second key frame 220, and a third key frame 240, respectively. In the present embodiment, the present invention designates the frames with change of scenes as key frames. By which one knows that the first key frame 200 is located in the first frame of the plurality of frames in the first scene 20, and the first frame of the second scene 22 is the second key frame 220, and so on. Thereby each of the plurality of key frames 40 corresponds to a scene of the recording media 2. And the selection unit 6 provides the users with the ability to pick out at least one selected frame 60 from said plurality of key frames 40. In the present embodiment, because the user selects the first key frame 200 and the second key frame 220, thereby the first key frame 200 is a first selected frame 62, and the second key frame 220 is a second selected frame 64. In addition, in accordance with the selected frame 60, the output unit 8 extracts the corresponding scene, and outputs or bums a multimedia file 14 including the extracted scene to a hard disk or into an optical disc, respectively.

The said key frame is located in the first frame of a scene. However, in practical applications, the key frame is allowed to be any of the plurality of frames corresponding to the scene. That is, a key frame can be located in any other frame in a scene.

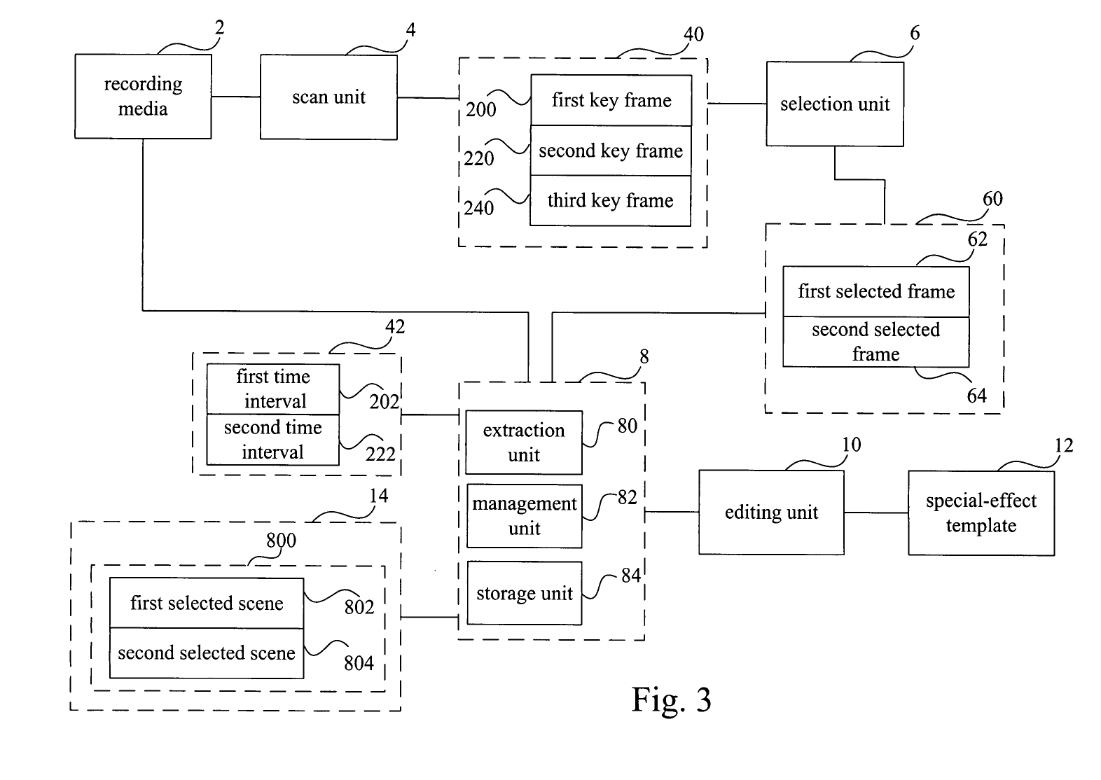

Referring to FIG. 3, another preferred embodiment of the present invention is shown. As shown in the figure, the system shown in FIG. 3 is similar to the one shown in FIG. 2A, wherein the scan unit 4 detects the change of scenes via the recording times of the plurality of frames in the recording media 2. By which means the fact that a plurality of scenes is divided in the recording media is known, and the time intervals corresponding to each of the plurality of scenes can be stored in the recording media 2. The time intervals include a first time interval 202, a second time interval 222, wherein the first time interval 202 records the start time and stop time corresponding to the first scene, and the second time interval 222 records the start time and stop time corresponding to the second scene, and so on. Accordingly, each of the plurality of time intervals corresponds to one of the scenes in the recording media 2. An editing unit 10 provides at least one special-effect template 12. A user can select the special-effect template 12 to edit the first selected frame 62 and the second selected frame 64 via the selection unit 6, wherein the special-effect template 12 can be a transition effect, a special effect of playing menu, a background sound effect, or a related multimedia special effect.

In addition, the output unit 8 further includes an extraction unit 80, a management unit 82, and a storage unit 84, wherein according to the first selected frame 62 and the second selected frame 64, the extraction unit 80 extracts at least one corresponding time interval 42, which includes the first time interval 202 and the second time interval 222. Moreover, according to the time interval 42, the extraction unit 80 also extracts at least one selected scene 800, which includes a first selected scene 802 and a second selected scene 804. The management unit 82 applies the special effect 12 to the selected scene 800 in order to generate the corresponding multimedia file 14. And the storage unit 84 is used to store the multimedia file 14.

In addition, when the present invention is used to extract the information including the recording media of digital television signals, because digital television signals are compressed in MPEG format and include an electronic program guide, by interpreting the electronic program guide, one can acquire program information of respective channels and broadcasting schedules as well. Thereby, by way of the provided information of program schedules in the electronic program guide, the reference for extracting length of media can be given.

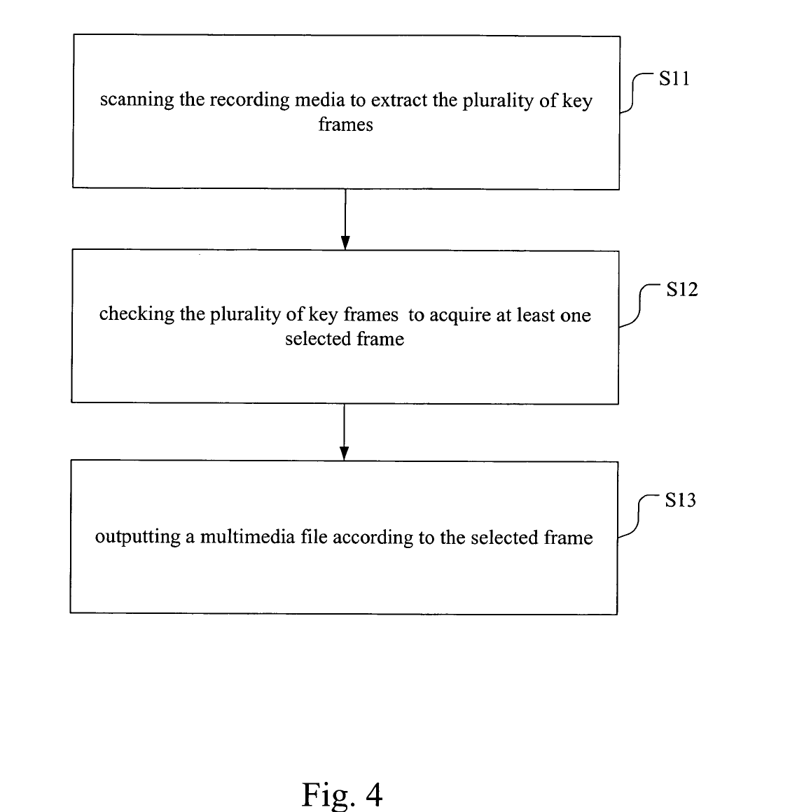

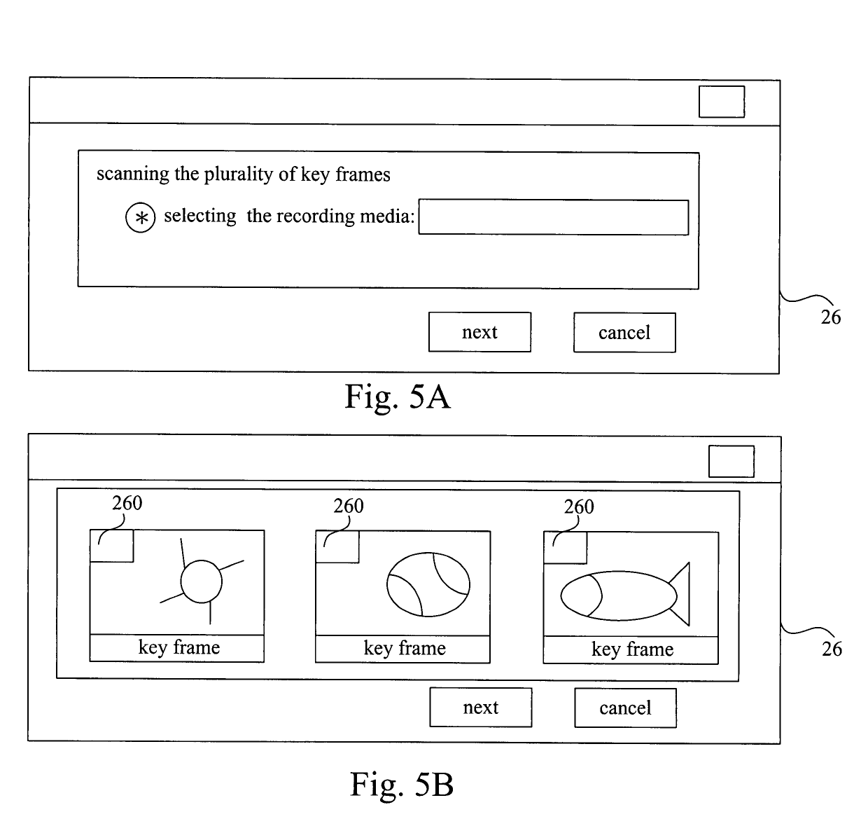

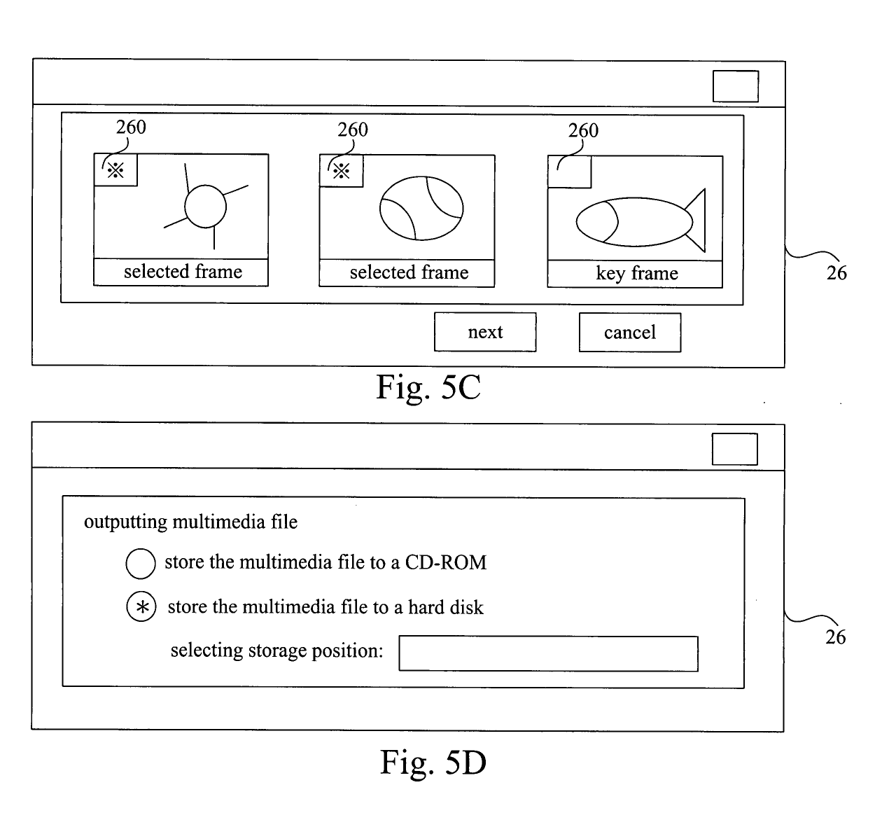

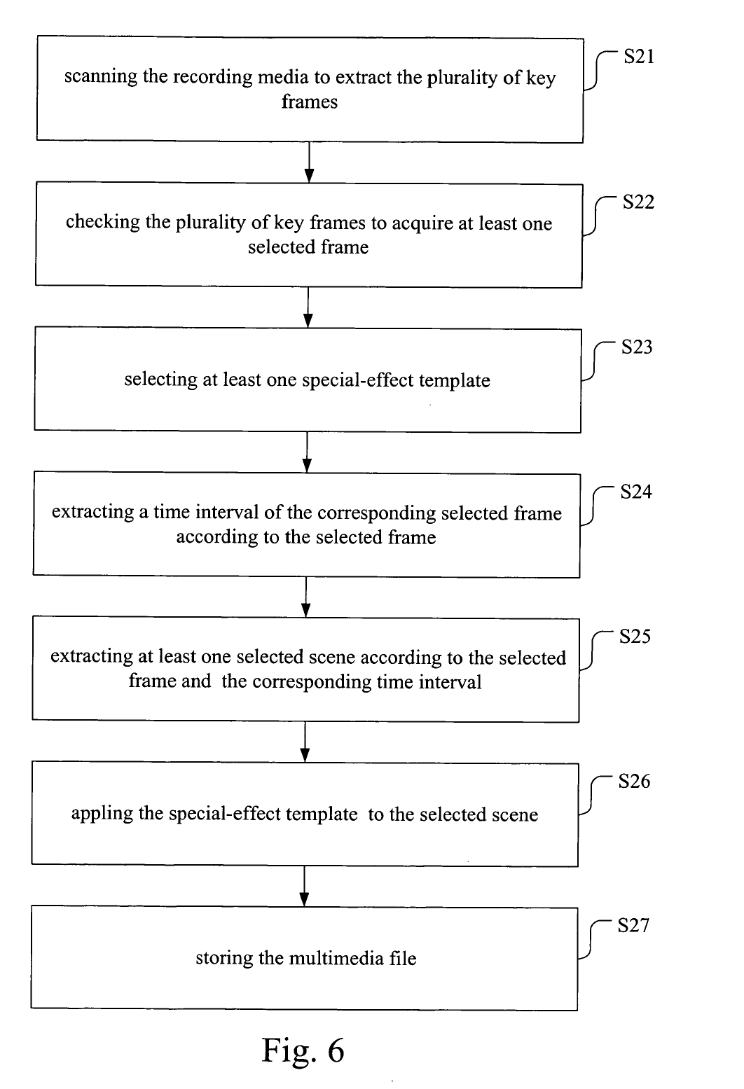

Referring to FIG. 4, a flow chart of a preferred embodiment of the present invention is shown. As shown in the figure together with FIG. 5A, when a user wants to extract information from the recording media, he/she selects the recording media to be scanned on a multimedia editing panel 26 such that the recording media can be scanned to extract the plurality of key frames according to a step S11, wherein each key frame corresponds to a scene of the recording media. Then, a step S12 is executed. Referring to FIG. 5B as well as FIG. 5C, as shown in the figures, the multimedia editing panel 26 presents the plurality of key frames and a plurality of selection boxes 260. The user can check the selection boxes 260 such that at least one selected frame can be acquired. After that, a step S13 is carried out. In which step, a multimedia file is output according to the selected frame. Referring to FIG. 5D, the user can store the multimedia file to a hard disk or an optical disc according to the multimedia editing panel 26. Referring to FIG. 6, a flow chart of another preferred embodiment of the present invention is shown. As shown in the figure, after a user acquires at least one selected frame according to a step S21 and a step S22, he/she then selects at least one special-effect template according to a step S23 in order to provide the capability of editing the selected frame. Afterwards, a step S24 is executed according to the selected frame to extract a time interval of the corresponding selected frame, and a step S25 is carried out according to the selected frame and the corresponding time interval to extract at least one selected scene. Then, by means of a step S26, the special-effect template is applied to the selected scene to provide a multimedia file and a step S27 is executed to store the multimedia file, wherein the steps from S24 to S27 in the present embodiment are the detailed procedures of the said step S13.

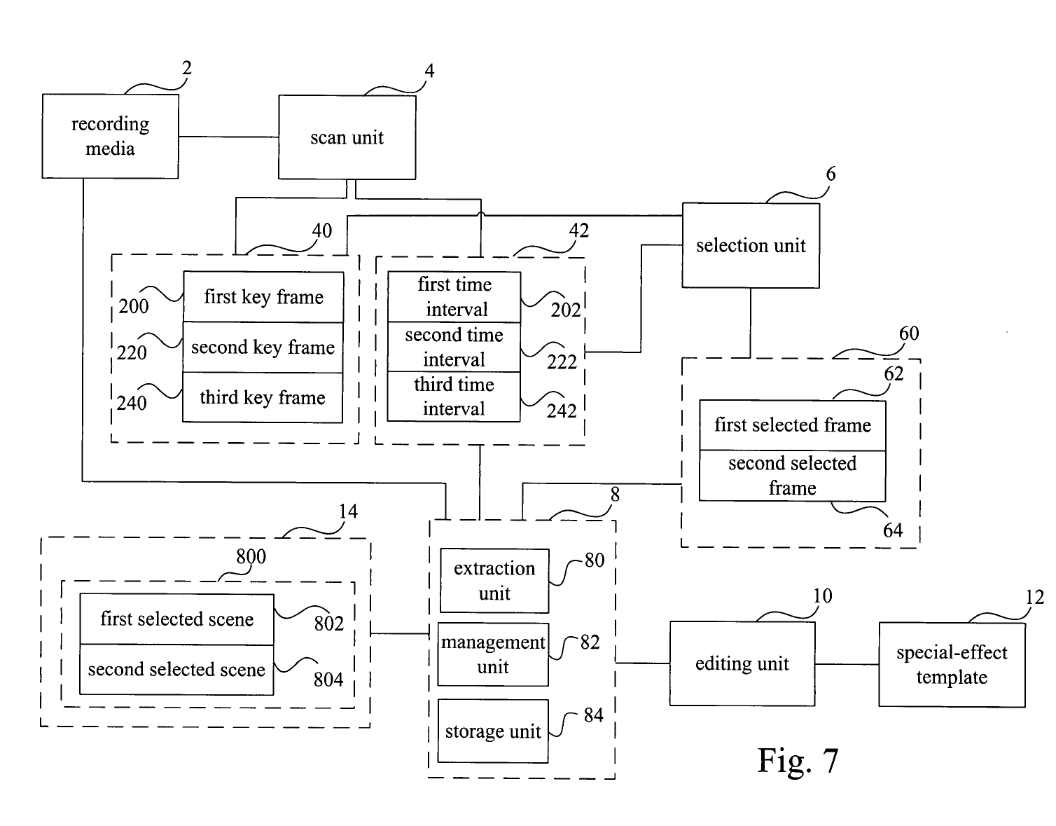

Referring to FIG. 7, a schematic diagram of another preferred embodiment of the present invention is shown. As shown in the figure, the system shown in FIG. 7 is similar to the one shown in FIG. 2A. In the present embodiment, the scan unit 4 scans the recording media 2 to acquire key frames and at least one time interval 42 of the corresponding key frames; that is, it acquires the first time interval 202 corresponding to the first key frame 200, the second time interval 222 corresponding to the second key frame 220, and the third time interval 242 corresponding to the third key frame 240, respectively. In this way, the selection unit 6 can select at least one selected frame 60 according to the key frames. The extraction unit 80 of the output unit 8 further acquires the selected scene 800 according to the selected frame 60 and the corresponding time interval, and outputs the multimedia files 14 including the selected scene 800 via the management unit 82 and the storage unit 84.

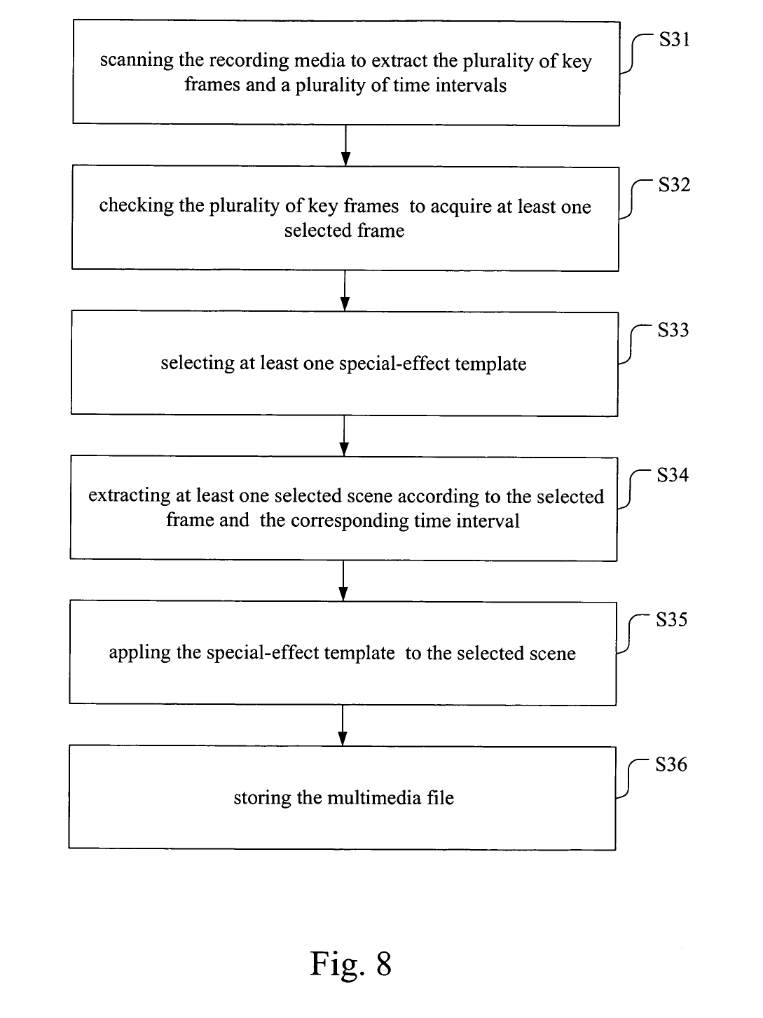

Referring to FIG. 8, a flow chart of another preferred embodiment of the present invention is shown. As shown in the figure, the present invention provides another method for a user to extract information from a recording media. Firstly, a step S31 is executed. The present embodiment is different from the step S21 shown in FIG. 6. The step S31 scans the recording media to extract a plurality of key frames and a plurality of time intervals, wherein each of the plurality of key frames and each of the plurality of time intervals corresponds to a scene of the recording media. Then, after acquiring the selected frame and selecting the desired special-effect template according to a step S32 and a step S33, a step S34 is executed. At step S34, the selected scene is acquired according to the selected frame and the corresponding time interval, and then via a step S35 and a step S36 a multimedia file which includes the selected scene is output. In the present embodiment, the steps S32, S33, S35, and S36 are the same as the steps S22, S23, S26, and S27 referred in FIG. 6, therefore the details are not repeated here.

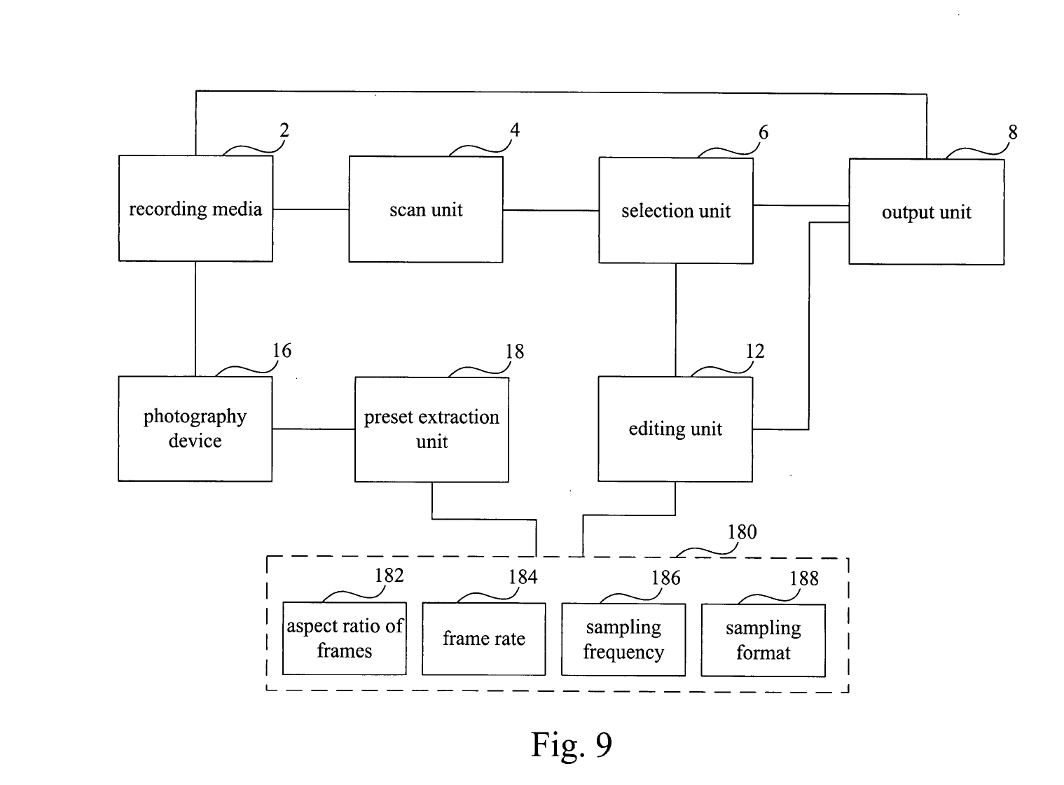

Referring to FIG. 9, a schematic diagram of special-effect templates corresponding to environment configurations provided by the present invention is shown. As shown in the figure, in the present embodiment, the present invention further includes a photography device 16, in which the recording media 2 is located, and a preset extraction unit 18, which is used to provide the editing unit 12 with the corresponding special-effect template according to an environment configuration 180, wherein the environment configuration 180 includes an aspect ratio of frames 182, a frame rate 184, a sampling frequency 186, and a sampling format 188. That is to say, the editing unit 12 can provide a multimedia special effect with an aspect ratio 182 of 16:9 according to a size configuration with an aspect ratio 182 of 4:3. In this way, users can apply the multimedia special effect with an aspect ratio 182 of 16:9 to the selected scene.

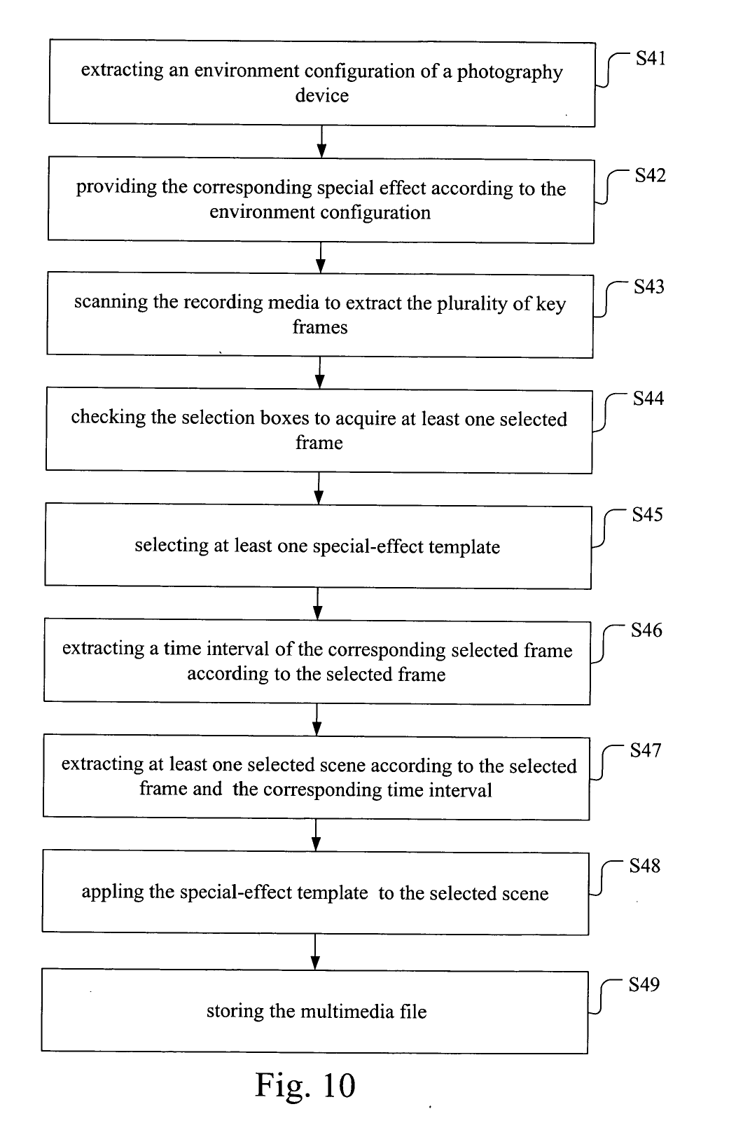

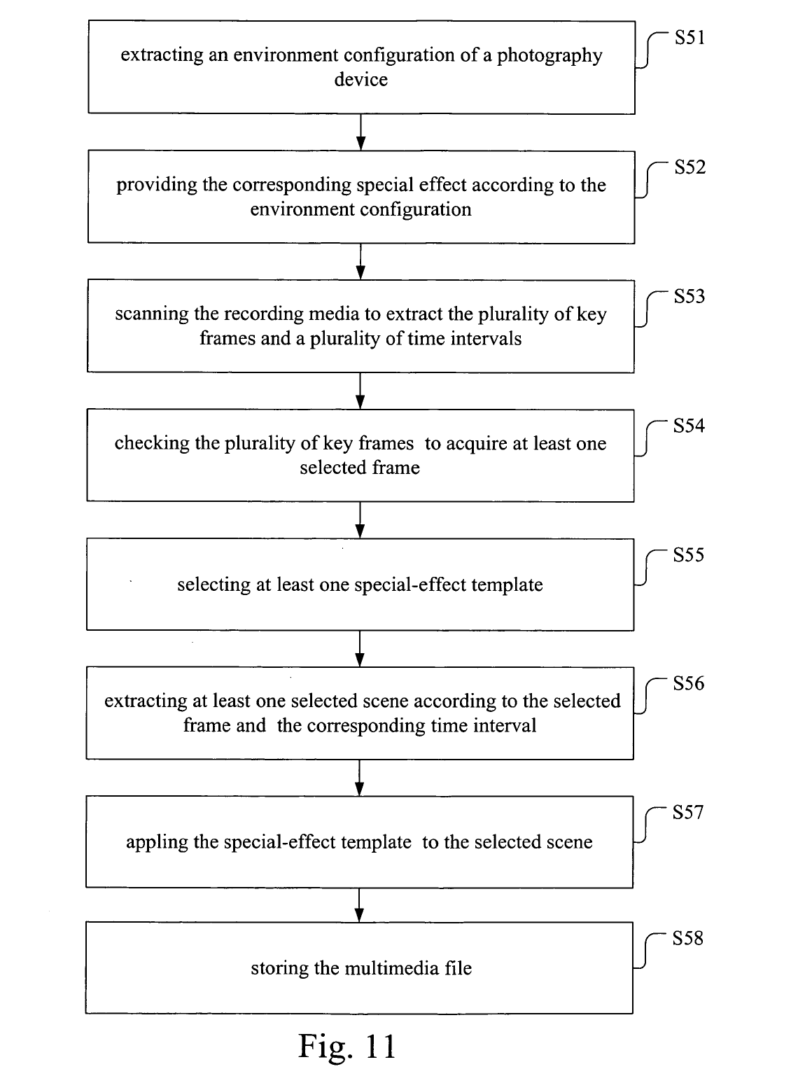

Referring to FIG. 10 and FIG. 11, the methods illustrated in these two figures are similar to the methods illustrated in FIG. 6 and FIG. 8, respectively. However, the distinction lies on that in the present invention, in addition to providing common special-effect templates for editing movies, the present invention extracts an environment configuration of a photography device according to a step S41 and a step S51 respectively, and provides at least one corresponding special effect according to the environment configuration by means of executing a step S42 and a step S52 respectively. Then, the present invention outputs the multimedia file by further executing the steps S43 through S49, and the steps S53 through S58, respectively. Thereby, the user can apply the special-effect template of the corresponding environment configuration to a selected scene. In this way, the viewing qualities of a multimedia file can be improved. The above-mentioned steps S43 through S49 are referred to the steps S21 through S27 shown in FIG. 6, as well as the steps S53 through S58 are referred to the steps S31 through S36 shown in FIG. 8.

To sum up, the present invention relates to a system and a method for extracting data from recording media. By means of operation in coordination by a scan unit, a selection unit, and an output unit, as well as by acquisition of a plurality of key frames, the present invention allows of processing only the plurality of key frames such that the amount of information needed to be processed can be reduced. Not all frames of the desired scenes are extracted from the recording media until when a user wishes to output a multimedia file, so that the process time required for extracting data from the recording media can be concentrated in the step of outputting multimedia files, thereby the waiting time of processes can be reduced while the user executing each operation step. In this way, the user can execute the step of extraction from recording media rapidly. Moreover, after executing the step of outputting the multimedia file, the user can work on other tasks. When his/her other tasks are finished, he/she can then return to check if the outputting task of the multimedia file is completed or not. Accordingly, the present invention improves effectively the prior-art procedure of operation for extracting data from recording media, as well as enhancing the usage convenience. In addition, the present invention further provides an editing unit for the user to apply special-effect templates to the multimedia files extracted from the recording media. Furthermore, the present invention can extract environment configurations of photography devices in advance to provide the editing unit for supplying the corresponding special-effect templates. Thereby the viewing quality of multimedia can be improved.

The present invention conforms to the legal requirements owing to its novelty, unobviousness, and utility. However, the foregoing description of embodiment is only a preferred embodiment of the present invention, not used to limit the scope and range of the present invention. Those equivalent changes or modifications made according to the shape, structure, feature, or spirit described in the claims of the present invention is included in the appended claims of the present invention.

What is claimed is:

1. A method of extracting data from a recording media, comprising:
scanning a recording media, to extract a plurality of key frames and a plurality of time intervals, wherein each of the plurality of key frames and each of the plurality of time intervals correspond to a scene of the recording media;
selecting the plurality of key frames, to acquire at least one selected frame; and
outputting a multimedia file according to the selected frame and the corresponding time interval.

2. The method of claim 1, wherein before scanning the recording media further comprises:
extracting an environment configuration of a photography device; and
providing at least one corresponding special-effect template according to the environment configuration.

3. The method of claim 1, wherein before outputting a multimedia file according to the selected frame and the corresponding time interval further comprises:
selecting at least one special-effect template to edit the selected frame.

4. The method of claim 3, wherein during outputting a multimedia file according to the selected frame and the corresponding time interval further comprises:
extracting at least one selected scene according to the selected frame and the corresponding time interval;
applying the special-effect template to the selected scene, to generate the multimedia file; and
storing the multimedia file.

5. A method of extracting data from a recording media, comprising:
scanning a recording media, to extract a plurality of key frames, wherein each of the plurality of key frames corresponds to a scene of the recording media;
selecting the plurality of key frames, to acquire at least one selected frame; and
outputting a multimedia file according to the selected frame.

6. The method of claim 5, wherein before scanning the recording media further comprises:
extracting an environment configuration of a photography device; and
providing at least one corresponding special-effect template according to the environment configuration.

7. The method of claim 5, wherein before outputting a multimedia file according to the selected frame further comprises:
selecting at least one special-effect template to edit the selected frame.

8. The method of claim 7, wherein during outputting a multimedia file according to the selected frame further comprises:
extracting at lease one time interval according to the selected frame;
extracting at least one selected scene according to the selected frame and the corresponding time interval;
applying the special-effect template to the selected scene, to generate the multimedia file; and
storing the multimedia file.

9. A system of extracting data from a recording media, comprising:
a scan unit, which scans a recording media to extract a plurality of key frames, wherein each of the plurality of key frames corresponds to a scene of the recording media;
a selection unit, which selects the plurality of key frames to acquire at least one selected frame; and
an output unit, which outputs a multimedia file according to the selected frame.

10. The system of claim 9, wherein each scene comprises a plurality of frames, and each of the plurality of key frames can be any one of the plurality of frames corresponding to the scene.

11. The system of claim 9, further comprising an editing unit, which provides at least one special-effect template for a user to edit the selected frame.

12. The system of claim 11, wherein the special-effect template can be a transition effect, a special effect of playing menu, a background sound effect, or a related multimedia special effect.

13. The system of claim 9, further comprising a preset extraction unit, which extracts an environment configuration of the photography device.

14. The system of claim 13, wherein the environment configuration includes an aspect ratio of frames, a frame rate, a sampling frequency, and a sampling format.

15. The system of claim 14, wherein an editing unit provides at least one special-effect template according to the environment configuration.

16. The system of claim 9, wherein the scan unit scans the recording media to extract a plurality of time intervals, wherein each of the plurality of time intervals includes a start time and an end time corresponding to the scene.

17. The system of claim 16, wherein the output unit further comprises:
an extraction unit, which extracts at least one selected scene according to the selected frame and the corresponding time interval;
a management unit, which applies at least one special-effect template to the selected scene to generate the multimedia file; and
a storage unit, which stores the multimedia file.

18. The system of claim 9, wherein the output unit further comprises:
an extraction unit, which extracts at least one time interval corresponding to the selected frame, and extracts at least one selected scene according to the time interval;
a management unit, which applies at least one special-effect template to the selected scene to generate the multimedia file; and
a storage unit, which stores the multimedia file.

19. The system of claim 9, wherein the recording media can be a magnetic tape, a memory card, a videotape, or a digital disc.
